(19) United States
(12) Patent Application Publication
(10) Pub. No.: US 2026/0058067 A1
(43) Pub. Date: Feb. 26, 2026

(54) ELECTROLYTIC CAPACITOR AND METHOD FOR MANUFACTURING ELECTROLYTIC CAPACITOR

(71) Applicant: Panasonic Intellectual Property Management Co., Ltd., Osaka (JP)

(72) Inventors: Yukiya SHIMOYAMA, YAMAGUCHI KEN (JP); Tomoyuki TASHIRO, YAMAGUCHI KEN (JP); Shumpei MATSUSHITA, YAMAGUCHI KEN (JP); Honami KOJIMA, OSAKA FU (JP)

(21) Appl. No.: 18/997,750

(22) PCT Filed: Jul. 27, 2023
(86) PCT No.: PCT/JP2023/027572

§ 371 Date: Jan. 22, 2025

(30) Foreign Application Priority Data
Jul. 29, 2022 (JP) 2022-121582

(51) Int. Cl. H01G 9/02; H01G 9/00; H01G 9/028; H01G 9/035; H01G 9/145; H01G 9/15

(52) U.S. Cl. CPC H01G 9/02; H01G 9/0029; H01G 9/028; H01G 9/035; H01G 9/145; H01G 9/151

(57) ABSTRACT

An electrolytic capacitor disclosed herein includes: a stacked body of an anode foil having a dielectric layer formed on a surface thereof and a cathode foil; and a layer containing a conductive polymer and an insulating material disposed between the dielectric layer and the cathode foil. The insulating material is at least one kind of material selected from the group consisting of insulating fibers and insulating particles. No separator is disposed between the anode foil and the cathode foil.

### TECHNICAL FIELD

The present disclosure relates to an electrolytic capacitor and a method for manufacturing an electrolytic capacitor.

### BACKGROUND ART

An electrolytic capacitor that includes a wound body including an anode foil, a separator, and a cathode foil is known. An example of such an electrolytic capacitor includes a conductive polymer layer disposed inside the wound body. The conductive polymer layer is formed by impregnating the wound body with a dispersion liquid that contains particles of a conductive polymer, for example. Various proposals have been made for an electrolytic capacitor including a conductive polymer layer and a method for manufacturing the same.

PTL 1 (Japanese Patent No. 5062738) discloses “a conductive composition comprising a conductive polymer synthesized by oxidatively polymerizing pyrrole or a derivative thereof using an organic sulfonate and a persulfate, the organic sulfonate being constituted of a polystyrene sulfonate having a number average molecular weight of 10000 to 300000 and an aromatic sulfonate, an aromatic sulfonic acid portion of the aromatic sulfonate being 20% by mass to 50% by mass relative to a polystyrene sulfonic acid portion of the polystyrene sulfonate, wherein a pH of a dispersion liquid having a total concentration of 1% by mass of the conductive polymer and a component derived from an added pH improver is 1.5 to 4.5″.

PTL 2 (Japanese Laid-Open Patent Publication No 2007-27767) discloses a method comprising the steps of: applying a) a dispersion containing at least b) particles of a predetermined conductive polymer, c) a binder, and d) a dispersant to a capacitor body containing at least a solid electrolyte; and removing at least a portion of the d) dispersant and/or curing the c) binder to form a conductive polymer outer layer.

PTL 3 (Japanese Patent No. 6951159) discloses “a capacitor comprising: an anode made of a valve metal; a dielectric layer made of an oxide of the valve metal; a cathode made of a conductive material provided opposite the anode on the dielectric layer; and a solid electrolyte layer formed between the dielectric layer and the cathode, the solid electrolyte layer having a conductive complex containing a π-conjugated conductive polymer and a polyanion, and a binder, wherein the binder contains a styrene-butadiene rubber”.

### CITATION LIST

### Patent Literature

PTL 1: Japanese Patent No. 5062738
PTL 2: Japanese Laid-Open Patent Publication No 2007-27767
PTL 3: Japanese Patent No. 6951159

### SUMMARY OF INVENTION

### Technical Problem

By using a separator, the distance between the anode foil and the cathode foil can be prevented from being too short. Therefore, by using a separator, it is possible to suppress short circuits, an increase in leakage current, a decrease in withstand voltage, etc. On the other hand, the presence of the separator reduces the volumetric capacity density (capacity density per unit volume).

In such a situation, one of the objects of the present disclosure is to provide an electrolytic capacitor that is highly reliable even without a separator, and a manufacturing method for manufacturing the same.

### Solution to Problem

One aspect of the present disclosure relates to an electrolytic capacitor. The electrolytic capacitor includes: a stacked body of an anode foil having a dielectric layer formed on a surface thereof and a cathode foil; and a layer containing a conductive polymer and an insulating material disposed between the dielectric layer and the cathode foil, wherein the insulating material is at least one kind of material selected from the group consisting of insulating fibers and insulating particles, and No separator is disposed between the anode foil and the cathode foil.

Another aspect of the present disclosure relates to a manufacturing method for manufacturing an electrolytic capacitor including an anode foil having a dielectric layer formed on a surface thereof and a cathode foil. The manufacturing method includes a step (i) of applying a dispersion containing a conductive polymer and an insulating material to at least one element selected from the dielectric layer and the cathode foil, and drying the dispersion, thereby forming a layer containing the conductive polymer and the insulating material on the at least one element; and a step (ii) of stacking the anode foil and the cathode foil such that the layer is disposed between the dielectric layer and the cathode foil, thereby forming a stacked body, the step (i) and the step (ii) being carried out in the stated order, wherein the insulating material contains at least one kind of material selected from the group consisting of insulating fibers and insulating particles, and in the step (ii), the anode foil and the cathode foil are stacked with no separator therebetween.

### Advantageous Effects of Invention

According to the present disclosure, it is possible to obtain a highly reliable electrolytic capacitor even without a separator. The electrolytic capacitor can have a high volumetric capacitance density.

While novel features of the present invention are set forth in the appended claims, both the configuration and content of the present invention, as well as other objects and features of the present invention, will be better understood from the following detailed description given with reference to the drawings.

### BRIEF DESCRIPTION OF DRAWINGS

FIG. 1 is a side view schematically showing an electrolytic capacitor according to an embodiment of the present disclosure.

FIG. 2 is an exploded perspective view schematically showing a capacitor element according to an embodiment of the present disclosure.

FIG. 3A is a cross-sectional view schematically showing a portion of an example of an anode foil on which layers containing a conductive polymer are formed.

FIG. 3B is a cross-sectional view schematically showing a portion of another example of an anode foil on which layers containing a conductive polymer are formed.

### DESCRIPTION OF EMBODIMENTS

The following describes an example embodiment of the present disclosure, but the present disclosure is not limited to the following example. In the following description, specific numerical values and materials are given as examples in some cases, but other numerical values and other materials may also be applied as long as the advantageous effects of the present disclosure can be achieved. In this specification, the expression “a numerical value A to a numerical value B” includes the numerical value A and the numerical value B, and can be read as “not less than the numerical value A and not greater than the numerical value B”. In the following description, if lower and upper limits of numerical values related to specific physical properties, conditions, etc. are illustrated, any of the illustrated lower limits and any of the illustrated upper limits can be combined as desired as long as the lower limit is not equal to or greater than the upper limit. In the following description, when examples of components are listed, only one of the listed examples may be used, or two or more of the listed examples may be used in combination, unless otherwise noted.

### (Method for Manufacturing Electrolytic Capacitor)

The manufacturing method according to the present embodiment is a method for manufacturing an electrolytic capacitor including an anode foil having a dielectric layer formed on the surface thereof and a cathode foil. Hereinafter, this manufacturing method may be referred to as a “manufacturing method (M)”. The manufacturing method (M) includes the steps (i) and (ii) in the stated order. These steps are described below.

### (Step (i))

The step (i) is a step of applying a dispersion containing a conductive polymer and an insulating material to at least one element selected from a dielectric layer formed on a surface of an anode foil, and a cathode foil, and drying the dispersion, thereby forming a layer containing the conductive polymer and the insulating material on the at least one element. Hereinafter, the insulating material, the dispersion, and the layer may be referred to as an “insulating material (I)”, a “dispersion (D1)”, and a “layer (PL)”, respectively.

The dispersion (D1) contains the insulating material (I). Therefore, when a stacked body is formed by forming the layer (PL) using the dispersion (D1), the gap between the anode foil and the cathode foil is ensured by the insulating material (I). Therefore, by using the dispersion (D1), it is possible to obtain an electrolytic capacitor that is highly reliable even without a separator. By not using a separator, it is possible to reduce the ESR of the electrolytic capacitor. Furthermore, by not using a separator, it is possible to increase the volumetric capacitance density of the electrolytic capacitor.

The methods for applying and drying the dispersion (D1) are not particularly limited, and any known methods may be used. The application method may be a method using a coater or a method of spraying the dispersion (D1). Alternatively, the at least one element may be immersed in the dispersion (D1). The dispersion (D1) may be dried by removing at least a portion of the dispersion medium by heating. For example, heating may be performed at a temperature of 100° C. or higher (e.g., 120° C. or higher, or 140° C. or higher). There is no upper limit to the heating temperature, but the temperature is such that it does not affect components such as the conductive polymer, for example, at 160° C. or lower. There is no limitation on the heating time, and the heating time may be determined taking into consideration the amount of evaporation of the dispersion medium, etc. Drying may be carried out under reduced pressure. These application and drying methods can also be applied to the application and drying methods described below.

The at least one element may be the dielectric layer, the cathode foil, or the dielectric layer and the cathode foil. The at least one element preferably includes the dielectric layer. By forming the layer (PL) on the dielectric layer, it is possible to dispose the insulating material (I) in the defective portion of the dielectric layer. This makes it possible to suppress performance degradation (such as an increase in leakage current and a decrease in withstand voltage) caused by the conductive polymer adhering to the defective portion of the dielectric layer on the surface of the anode foil.

From one perspective, the layer (PL) is a conductive polymer layer containing a conductive polymer. The layer (PL), or the layer (PL) and a liquid component (L) described below, can function as an electrolyte.

A thickness T of the conductive polymer layer (including the layer (PL)) disposed between the anode foil and the cathode foil is preferably 10 μm or more, 30 μm or more, or 50 μm or more. By setting the thickness T to 30 μm or more, a sufficient distance between the anode foil and the cathode foil can be ensured. The upper limit of the thickness T is not particularly limited, but a conductive polymer layer that is too thick reduces the effect of not using a separator and increases the formation time and cost. Therefore, the thickness T may be 80 μm or less, or 60 μm or less.

When the conductive polymer layer disposed between the anode foil and the cathode foil is constituted of the layer (PL) alone, the thickness of the layer (PL) may be within the range illustrated for the thickness T. When the conductive polymer layer disposed between the anode foil and the cathode foil is constituted of the layer (PL) and another conductive polymer layer (e.g., a second conductive polymer layer described later), the thickness of the layer (PL) may be in a range smaller than the range illustrated for the thickness T.

### (Insulating Material (I))

The insulating material (I) contains at least one kind of material selected from the group consisting of insulating fibers and insulating particles. The insulating material (I) may be constituted of insulating fibers alone, insulating particles alone, or both of them. The insulating material (I) preferably contains insulating fibers from the standpoint that the insulating fibers are likely to adhere uniformly to the dielectric layer. By including the insulating material (I), even if a separator is not used in the electrolytic capacitor, a decrease in withstand voltage and an increase in leakage current can be suppressed.

The insulating fibers used as the insulating material (I) may include fibers containing at least one kind of material selected from the group consisting of cellulose, rayon, aramid, polyester, polyimide, and nylon, or may be fibers made of the at least one kind of material. By using these insulating fibers, the dispersibility in the dispersion (D1) can be increased, and a decrease in the withstand voltage of the electrolytic capacitor can be significantly suppressed. Alternatively, insulating fibers other than these fibers may be used.

The average diameter of the insulating fibers may be 0.1 μm or more, 1 μm or more, or 10 μm or more, and may be 100 μm or less, or 50 μm or less. The cross section of the insulating fibers may be substantially a perfect circle, or may have another shape (e.g., an ellipse). The diameter of fibers means the equivalent circle diameter. By setting the average diameter of the insulating fibers in the range of 1 μm to 50 μm (e.g., in the range of 10 μm to 50 μm), the advantageous effects of the present disclosure can be enhanced. The average fiber diameter is determined by measuring the diameter (equivalent circle diameter) at any position of thirty randomly selected fibers and calculating the arithmetic mean of the thirty measured diameters. The equivalent circle diameter can be measured, for example, by analyzing an image of the cross section of each fiber.

The insulating fibers may have an average fiber length of 100 μm or more. The upper limit of the average fiber length is not particularly limited, and may be, for example, 5000 μm or less. The average fiber length is obtained by calculating the arithmetic mean of the lengths of thirty fibers.

The insulating particles used as the insulating material (I) may include particles containing at least one kind of material selected from the group consisting of polyolefin, polyester, polytetrafluoroethylene, and ceramic (insulating ceramic) from the standpoint of suppressing a decrease in the withstand voltage of the electrolytic capacitor, or may be particles constituting of the at least one kind of material. Alternatively, insulating particles other than these particles may be used.

The average particle diameter of the insulating particles may be 0.1 μm or more, 10 μm or more, or 20 μm or more, and may be 100 μm or less, or 50 μm or less. In this specification, the average particle diameter is the median diameter (D50) at which the cumulative volume in the volume based particle size distribution is 50%. The median diameter is determined using a laser diffraction/scattering type particle size distribution analyzer.

The shape of the insulating particles is not particularly limited, and may be spherical (including oval spherical shape, etc.), scale-like, needle-like, or lattice-like. Alternatively, the shape of the insulating particles does not need to be particularly determined.

Insulating fibers and insulating particles are commercially available in a variety of materials and shapes. For the insulating material (I), commercially available insulating fibers and/or insulating particles may be used. Alternatively, insulating fibers and/or insulating particles manufactured by a known method may be used.

The content Ci (% by mass) of the insulating material (I) in the dispersion (D1) may be 0.1% by mass or more, or 1.0% by mass or more, and may be 5.0% by mass or less, or 3.0% by mass or less. By setting the content to 1.0% by mass or more, the advantageous effects of the present disclosure can be enhanced. By setting the content to 3.0% by mass or less, a decrease in the conductivity of the conductive polymer layer can be suppressed.

The ratio Ci/Cc of the content Ci (% by mass) to the content Cc (% by mass) of the conductive polymer in the dispersion (D1) may be 0.1 or more, or 0.5 or more, and may be 2.0 or less, or 1.0 or less. By setting the ratio Ci/Cc to 0.5 or more, the advantageous effects of the present disclosure can be enhanced. By setting the ratio Ci/Cc to 1.0 or less, a decrease in the conductivity of the conductive polymer layer can be suppressed.

### (Dispersion Medium)

The dispersion medium is a medium in which the conductive polymer is dispersed. The dispersion medium preferably contains water. The water content in the dispersion medium may be 50% by mass or more, 70% by mass or more, 90% by mass or more, or 95% by mass or more. The water content may be 100% by mass. That is to say, the dispersion medium may be water. The dispersion medium may contain an organic solvent other than water. Note that an additive (A) is not contained in the dispersion medium.

### (Conductive Polymer)

The conductive polymer is not particularly limited, and may be any conductive polymer that can be used in an electrolytic capacitor. The conductive polymer may be a known conductive polymer used as an electrolyte in an electrolytic capacitor.

Examples of the conductive polymer include polypyrrole, polythiophene, polyfuran, polyaniline, polyacetylene, and derivatives thereof. The derivatives include polymers based on the main backbones of polypyrrole, polythiophene, polyfuran, polyaniline, and polyacetylene. For example, polythiophene derivatives include poly(3,4-ethylenedioxythiophene), etc. These conductive polymers may be used alone or in combination of two or more kinds. The conductive polymer may also be a copolymer of two or more kinds of monomers. The weight average molecular weight of the conductive polymer is not particularly limited, and may be in the range of 1000 to 100000, for example. A preferred example of the conductive polymer is poly(3,4-ethylenedioxythiophene) (PEDOT).

The conductive polymer may be doped with a dopant. From the standpoint of suppressing de-doping from the conductive polymer, it is preferable to use a polymer dopant as the dopant. Examples of polymer dopants include polyvinylsulfonic acid, polystyrenesulfonic acid, polyallylsulfonic acid, polyacrylsulfonic acid, polymethacrylsulfonic acid, poly(2-acrylamido-2-methylpropanesulfonic acid), polyisoprenesulfonic acid, polyacrylic acid, etc. These dopants may be used alone or in combination of two or more kinds. At least some of these dopants may be added in the form of a salt. A preferred example of the dopant is polystyrene sulfonic acid (PSS). In one preferred example, the conductive polymer is poly(3,4-ethylenedioxythiophene) and the dopant is polystyrenesulfonic acid.

The dopant may be a dopant containing an acidic group or a polymerer dopant containing an acidic group. Examples of the acidic group include a sulfonic acid group, a carboxyl group, etc. The polymer dopant containing an acidic group is a polymer in which at least some constituent units contain an acidic group. Examples of such a polymer dopant include the polymer dopants described above.

The weight average molecular weight of the dopant is not particularly limited. From the standpoint of facilitating formation of a uniform conductive polymer layer, the weight average molecular weight of the dopant may be in the range of 1000 to 100000.

When the conductive polymer doped with the dopant is used, the pH of the dispersion (D1) is preferably less than 7.0 in order to suppress de-doping of the dopant, and may be 6.0 or less, or 5.0 or less. The pH of the dispersion (D1) may be 1.0 or more, 2.0 or more, or 3.0 or more.

The conductive polymer may be present in the state of particles in the dispersion (D1). The average particle diameter (D50) of the conductive polymer particles may be 10 μm or more, or 20 μm or more, and may be 100 μm or less.

The content of the conductive polymer in the dispersion (D1) may be 0.5% by mass or more, or 1.0% by mass or more, and may be 4.0% by mass or less, 3.0% by mass or less, or 2.0% by mass or less. The content may be in the range of 0.5% by mass to 4.0% by mass, or in the range of 1.0% by mass to 4.0% by mass. Within either of these ranges, the upper limit may be 3.0% by mass or 2.0% by mass. The content is preferably in the range of 1.0% by mass to 5.0% by mass (e.g., in the range of 1.0% by mass to 3.0% by mass) in terms of achieving excellent physical properties of the dispersion (D1), excellent stability of the physical properties over time, and a good balance between the ESR of the electrolytic capacitor and the cost.

The mass of the dopant contained in the dispersion (D1) is not particularly limited, and may be in the range of 0.1 times to 5 times (e.g., in the range of 0.5 times to 3 times) the mass of the conductive polymer contained in the dispersion (D1).

The method for manufacturing the dispersion (D1) is not particularly limited. For example, the dispersion (D1) can be manufactured by dispersing and dissolving the components of the dispersion (D1) in a dispersion medium. Specifically, the components of the dispersion (D1) are added to the dispersion medium and stirred to manufacture the dispersion (D1).

### (Additive)

The dispersion (D1) may contain an additive containing hydroxy groups, and water serving as a dispersion medium. Hereinafter, the additive may be referred to as an “additive (A)”. The ratio Mh/Mt of the total formula weight Mh of the hydroxy groups contained in the additive (A) to the molecular weight Mt of the additive may be 0.001 or more. In the case of ethylene glycol (HO—CH₂—CH₂—OH), the molecular weight Mt is 62 and the total formula weight Mh of the two hydroxyl groups is 34. Therefore, Mh/Mt=34/62=0.55. When the molecular weight of the additive (A) is not constant, the weight average molecular weight is used as the molecular weight of the additive (A).

The conductive polymer (e.g., conductive polymer particles) and the insulating material (I) tend to aggregate. The addition of the additive (A) can prevent them from aggregating. Therefore, by forming a conductive polymer layer using the dispersion (D1) containing the additive (A), a conductive polymer layer having high dispersibility of the insulating material (I) can be formed.

The ratio Mh/Mt may be 0.03 or more, or 0.07 or more, and may be 0.9 or less. By setting the ratio Mh/Mt to 0.03 or more, the advantageous effects of the additive (A) can be sufficiently obtained.

The molecular weight of the additive (A) is preferably 500 or less. By setting the molecular weight to 500 or less, the dispersibility in the dispersion (D1) can be increased. As a result, the additive (A) is more likely to adhere to a defective portion of the dielectric layer. The lower limit of the molecular weight is not particularly limited, and may be 44 or more, 80 or more, or 150 or more. The molecular weight may be 500 or less, 400 or less, 200 or less, or 120 or less.

The number of hydroxy groups contained in the additive (A) may be one or more or two or more, and may be six or less or three or less. From the standpoint of repairing the defective portion of the dielectric layer, the number of hydroxyl groups is preferably 3 or less.

Examples of the additive (A) include polyols. In this specification, a polyol means an organic compound that contains two or more hydroxy groups. Examples of the polyol include glycols, glycerins, and sugar alcohols. The polyol may be a hydrocarbon compound substituted with two or more hydroxyl groups (e.g., an aliphatic hydrocarbon substituted with two or more hydroxyl groups). The additive (A) is preferably a compound that is soluble in water. The additive (A) may be an organic compound containing three or fewer hydroxy groups (e.g., a lower alcohol with three or fewer hydroxy groups). The molecular weight of the organic compound may be 500 or less.

Examples of glycols include alkylene glycols (such as ethylene glycol and propylene glycol), diethylene glycol, triethylene glycol, polyalkylene glycols (e.g., polyethylene glycol), polyoxyethylene polyoxypropylene glycol (ethylene oxide-propylene oxide copolymers), etc. Examples of glycerins include glycerin, polyglycerin, etc. Examples of sugar alcohols include mannitol, xylitol, sorbitol, erythritol, pentaerythritol, etc.

The additive (A) may be at least one kind of material selected from the group consisting of glycols, glycerins, and sugar alcohols. For example, the additive (A) may be at least one selected from the group consisting of ethylene glycol, polyethylene glycol, diethylene glycol, triethylene glycol, glycerin, polyglycerin, erythritol, xylitol, sorbitol, and mannitol. A preferred example of the additive (A) is ethylene glycol.

The ratio Ca/Ci of the content Ca (% by mass) of the additive (A) in the dispersion (D1) to the content Ci (% by mass) of the insulating material (I) in the dispersion (D1) may be 0.1 or more, or 1.0 or more, and may be 8.0 or less, or 4.0 or less.

The manufacturing method (M) may include a step of forming the conductive polymer layer using the dispersion (D2). The dispersion (D2) is the dispersion illustrated as the dispersion (D1) from which the insulating material (I) is removed. For example, a first conductive polymer layer (layer (PL1)) may be formed using the dispersion (D1), and thereafter a second conductive polymer layer may be formed on the first conductive polymer layer using the dispersion (D2). In the above steps, the step of applying and drying the dispersions (the dispersions (D1) and (D2)) may be carried out only once or may be repeated a plurality of times. By repeating the step a plurality of times, the conductive polymer layer can be made thicker.

(Step (ii))

The step (ii) is a step of stacking the anode foil and the cathode foil such that the layer (PL) is disposed between the dielectric layer formed on the surface of the anode foil and the cathode foil, thereby forming a stacked body. In the step (ii), the anode foil and the cathode foil are stacked with no separator therebetween. With the step (ii), a stacked body (capacitor element) with no separator disposed between the anode foil and the cathode foil can be formed. Therefore, it is possible to manufacture an electrolytic capacitor with a high volumetric capacitance density. Since the layer (PL) contains the insulating material (I), the distance between the anode foil and the cathode foil can be maintained. As a result, it is possible to suppress a decrease in performance caused by the anode foil and the cathode foil being too close to each other.

This manufacturing method is used for a stacked electrolytic capacitor. The capacitor element of a stacked electrolytic capacitor includes a stacked body constituted of at least one anode foil and at least one cathode foil. The stacked body may be formed by stacking them in one direction. In this case, the electrolytic capacitor may include a plurality of capacitor elements.

The stacked body may be a wound body obtained by winding an anode foil and a cathode foil. That is to say, in the step (ii), the anode foil and the cathode foil may be stacked by winding the anode foil and the cathode foil. In the wound body, the anode foil and the cathode foil are stacked in the radial direction. Therefore, the wound body is also a stacked body.

The manufacturing method (M) may further include a step (Z) of impregnating the stacked body with a liquid component after the step (ii). Hereinafter, the liquid component may be referred to as a “liquid component (L)”. The method for impregnating the stacked body with the liquid component (L) is not particularly limited. The step (Z) may be carried out by immersing the stacked body in the liquid component (L). Alternatively, the step (Z) may be carried out by housing the liquid component (L) and the stacked body in an exterior body (case). Examples of the liquid component (L) will be described later.

The manufacturing method (M) may include a step (Y1) and a step (Y2) after the step (ii) and before the step (Z). Hereinafter, the step (Y1) and the step (Y2) may be collectively referred to as “the steps (Y)”. The step (Y1) is a step of impregnating the stacked body with a treatment liquid containing water and an organic compound that contains two or more hydroxy groups. Hereinafter, the organic compound and the treatment liquid may be referred to as an “organic compound (C)” and a “treatment liquid(S)”. The step (Y2) is a step of evaporating at least a portion of the water in the treatment liquid(S).

By carrying out the step (Y), it is possible to dispose the organic compound (C) in the conductive polymer layer. This makes it easier to impregnate the stacked body with the liquid component (L) in the step (Z).

In the step (Y1), there is no limitation on the method for impregnating the stacked body with the treatment liquid(S). For example, the stacked body may be immersed in the treatment liquid(S). In the step (Y2), there is no limitation on the step of evaporating at least a portion of the water in the treatment liquid(S). The step (Y2) may be carried out under the conditions illustrated for drying the dispersion (D1).

Examples of the organic compound (C) include polyols. Examples of polyols include the compounds given as examples of the polyols for the additive (A).

The water content in the treatment liquid(S) may be 40% by mass or more, 60% by mass or more, 80% by mass or more, 90% by mass or more, or 95% by mass or more. The content may be 99% by mass or less, 95% by mass or less, 90% by mass or less, or 80% by mass or less.

The content of the organic compound (C) in the treatment liquid(S) may be 1.0% by mass or more, 5.0% by mass or more, 10% by mass or more, or 20% by mass or more. The content may be 60% by mass or less, 40% by mass or less, 20% by mass or less, or 10% by mass or less.

The stacked body (capacitor element) that has undergone the step (ii) is enclosed in an exterior body. In this manner, a stacked electrolytic capacitor can be manufactured. As described above, the step (Z) may be carried out after the step (ii). Alternatively, the step (Y) and the step (Z) may be carried out after the step (ii).

The impregnation of the stacked body with a liquid (such as the dispersion (D1), the dispersion (D2), the treatment liquid(S), the liquid component (L), or the like) may be carried out by immersing the stacked body in the liquid. Subsequent drying may be accomplished by heating the stacked body. Heating may be performed under reduced pressure.

An example of the configuration and components of an electrolytic capacitor manufactured by the manufacturing method (M) will be described below. Note that the configuration and components of the electrolytic capacitor are not limited to the following examples. As components other than the components characteristic of the present disclosure, known components of an electrolytic capacitor may be used.

The electrolytic capacitor includes a capacitor element. The capacitor element includes at least one anode foil, at least one cathode foil, and an electrolyte layer disposed between the anode foil and the cathode foil.

### (Anode Foil)

The anode foil may be a metal foil having a porous surface. The dielectric layer is formed on at least a portion of the surface of the anode foil. The thickness of the anode foil is not particularly limited and may be in the range of 15 μm to 300 μm.

As the material of the anode foil, a valve metal, an alloy containing a valve metal, or a compound of a valve metal can be used. Examples of the valve metal include titanium (Ti), tantalum (Ta), niobium (Nb), aluminum (Al), etc. The anode foil may be formed by etching the surface of a metal foil (e.g., aluminum foil) used as the material. The dielectric layer formed on the surface of the anode foil may be formed by subjecting the surface of the metal foil to a chemical conversion treatment. There is no limitation on the chemical conversion treatment method, and a known chemical conversion treatment method may be applied.

### (Cathode Foil)

The cathode foil is not particularly limited as long as it functions as a cathode. Examples of the cathode foil include metal foils (e.g., an aluminum foil). The type of metal is not particularly limited, and may be a valve metal or an alloy containing a valve metal. The thickness of the cathode foil is not particularly limited and may be in the range of 15 μm to 300 μm. The surface of the cathode foil may be roughened or subjected to a chemical conversion treatment as required.

The cathode foil may include a conductive coating layer. When the metal foil contains a valve metal, the coating layer may contain carbon and at least one kind of metal having a lower ionization tendency than the valve metal. This makes it easier to improve the acid resistance of the metal foil. When the metal foil contains aluminum, the coating layer may contain at least one selected from the group consisting of carbon, nickel, titanium, tantalum, and zirconium. In particular, the coating layer may contain nickel and/or titanium because of their low cost and resistance.

### (Electrolyte Layer)

As described above, the conductive polymer layer including the layer (PL), or the conductive polymer layer including the layer (PL) and the liquid component (L) can function as an electrolyte.

### (Liquid Component (L))

Examples of the liquid component (L) include a non-aqueous solvent and an electrolyte solution. As the electrolyte solution, it is possible to use a non-aqueous electrolyte solution containing a non-aqueous solvent and a solute dissolved in the non-aqueous solvent. The liquid component (L) may contain a small amount of water. In this specification, the liquid component (L) may be a component that is liquid at room temperature (25° C.) or a component that is liquid at a temperature at which the electrolytic capacitor is used.

The non-aqueous solvent may be an organic solvent or an ionic liquid. Examples of the non-aqueous solvent include polyhydric alcohols such as ethylene glycol and propylene glycol, cyclic sulfones such as sulfolane (SL), lactones such as γ-butyrolactone (γBL), amides such as N-methylacetamide, N,N-dimethylformamide, and N-methyl-2-pyrrolidone, esters such as methyl acetate, carbonate compounds such as propylene carbonate, ethers such as 1,4-dioxane, ketones such as methyl ethyl ketone, and formaldehyde.

It is also possible to use a polymer-based solvent as the non-aqueous solvent. Examples of the polymer-based solvent include polyalkylene glycol, derivatives of polyalkylene glycol, and compounds in which at least one hydroxyl group of a polyhydric alcohol is substituted with polyalkylene glycol (including derivatives thereof). Specific examples of the polymer-based solvent include polyethylene glycol (PEG), polyethylene glycol glyceryl ether, polyethylene glycol diglyceryl ether, polyethylene glycol sorbitol ether, polypropylene glycol, polypropylene glycol glyceryl ether, polypropylene glycol diglyceryl ether, polypropylene glycol sorbitol ether, and polybutylene glycol. Examples of the polymer-based solvent further include ethylene glycol-propylene glycol copolymer, ethylene glycol-butylene glycol copolymer, and propylene glycol-butylene glycol copolymer. A non-aqueous solvent may be used alone, or a mixture of two or more non-aqueous solvents may be used.

The liquid component (L) may contain an acid component and a base component. Examples of the acid component include maleic acid, phthalic acid, benzoic acid, pyromellitic acid, and resorcylic acid. Examples of the base component include 1,8-diazabicyclo[5,4,0]undecene-7, 1,5-diazabicyclo[4,3,0]nonene-5, 1,2-dimethylimidazolinium, 1,2,4-trimethylimidazoline, 1-methyl-2-ethyl-imidazoline, 1,4-dimethyl-2-ethylimidazoline, 1-methyl-2-heptylimidazoline, 1-methyl-2-(3′heptyl) imidazoline, 1-methyl-2-dodecylimidazoline, 1,2-dimethyl-1,4,5,6-tetrahydropyrimidine, 1-methylimidazole, 1-methylbenzoimidazole, etc.

The non-aqueous electrolyte solution contains a non-aqueous solvent and a solute (e.g., an organic salt) dissolved therein. Examples of the non-aqueous solvent constituting the non-aqueous electrolyte include the examples of the non-aqueous solvent mentioned above. Examples of the solute include an inorganic salt and an organic salt. An organic salt is a salt in which at least one of the anion and the cation contains an organic substance. Examples of the organic salt include trimethylamine maleate, triethylamine borodisalicylate, ethyldimethylamine phthalate, mono-1,2,3,4-tetramethylimidazolinium phthalate, mono-1,3-dimethyl-2-ethylimidazolinium phthalate, etc.

In order to suppress de-doping of the dopant, the pH of the liquid component (L) may be less than 7.0, or 5.0 or less, and may be 1.0 or more, or 2.0 or more. The pH may be 1.0 or more and less than 7.0 (e.g., within the range of 2.0 to 5.0).

### (Others)

The electrolytic capacitor may include other components (a lead, an exterior body, etc.) as required. The lead and the exterior body are not particularly limited, and known lead and exterior body may be used.

### (Electrolytic Capacitor)

Hereinafter, the electrolytic capacitor according to the present embodiment may be referred to as an “electrolytic capacitor (E)”. The electrolytic capacitor (E) can be manufactured by the manufacturing method (M) described above. The matters described about the manufacturing method (M) can also be applied to the electrolytic capacitor (E), and therefore, redundant descriptions thereof may be omitted. In addition, the matters described about the electrolytic capacitor (E) may also be applied to the manufacturing method (M). Note that the electrolytic capacitor (E) may be manufactured by a manufacturing method other than the manufacturing method (M).

The electrolytic capacitor (E) includes: a stacked body of an anode foil having a dielectric layer formed on a surface thereof and a cathode foil; and a layer (layer (PL)) containing a conductive polymer and an insulating material (insulating material (I)) disposed between the dielectric layer formed on the surface of the anode foil and the cathode foil. As described above, the insulating material (I) contains at least one kind of material selected from the group consisting of insulating fibers and insulating particles. No separator is disposed between the anode foil and the cathode foil.

The electrolytic capacitor (E) does not include a separator disposed between the anode foil and the cathode foil, and therefore the volumetric capacitance density can be increased. On the other hand, since the layer (PL) disposed between the anode foil and the cathode foil contains the insulating material (I), the distance between the anode foil and the cathode foil can be set to be equal to or greater than a certain value.

The layer (PL) may further contain the additive (A) containing a hydroxy group. The ratio Mh/Mt of the total formula weight Mh of the hydroxy groups contained in the additive (A) to the molecular weight Mt of the additive may be within the range described above.

The insulating fibers and the insulating particles used for the insulating material (I) have been described above, and therefore, redundant descriptions thereof may be omitted.

As described above, the stacked body may be a stacked body in which at least one anode foil and at least one cathode foil are stacked in one direction. Alternatively, the stacked body may be a wound body of an anode foil and a cathode foil.

The stacked body may be impregnated with a liquid component (L).

The ratio of the content of the conductive polymer to the content of the insulating material (I) in the layer (PL) may be within the range illustrated for the ratio Ci/Cc of the content Ci to the content Cc in the dispersion (D1). The ratio of the content of the additive A to the content of the insulating material (I) in the layer (PL) may be within the range illustrated for the ratio Ca/Ci of the content Ca to the content Ci in the dispersion (D1).

An example of the electrolytic capacitor (E) will be specifically described below with reference to the drawings. The components described above can be applied to the components of the example described below. In addition, the components of the example described below can be modified based on the above description. In addition, the matters described below may be applied to the above embodiment. In addition, in the example described below, components that are not essential to the electrolytic capacitor according to the present disclosure may be omitted.

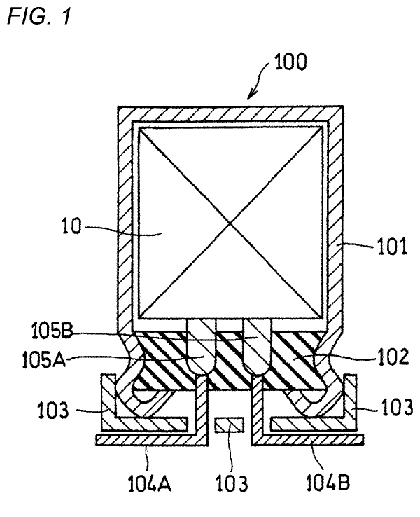

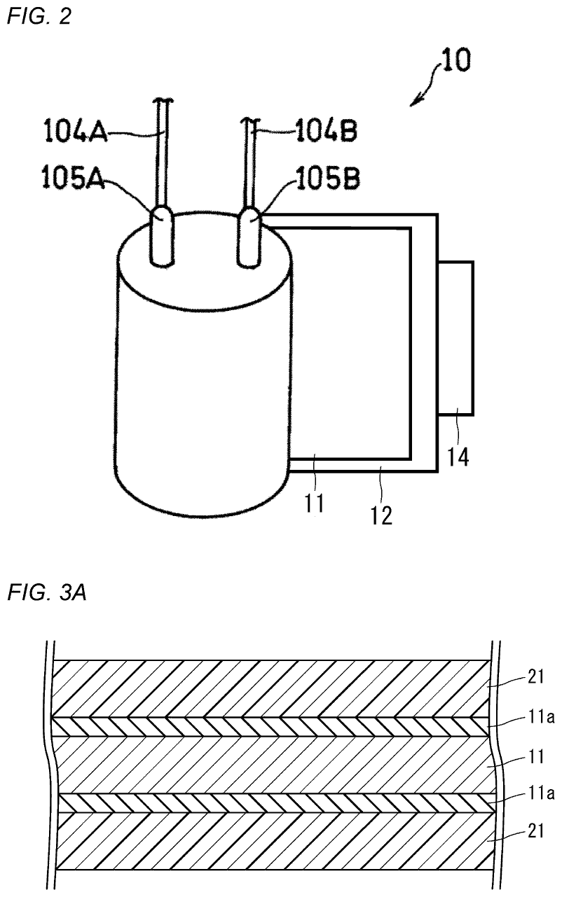

FIG. 1 is a cross-sectional view schematically showing an example of an electrolytic capacitor 100 according to the present embodiment. FIG. 2 is a schematic diagram in which a portion of a capacitor element 10 included in the electrolytic capacitor 100 is spread. The electrolytic capacitor 100 is a stacked capacitor including a wound body (stacked body).

The electrolytic capacitor 100 includes the capacitor element 10, a bottomed case 101 in which the capacitor element 10 is housed, a sealing member 102 sealing an opening of the bottomed case 101, a base plate 103 covering the sealing member 102, lead wires 104A and 104B drawn out from the sealing member 102 and passing through the base plate 103, and lead tabs 105A and 105B connecting the lead wires and electrodes of the capacitor element 10. The vicinity of an open end of the bottomed case 101 is pressed inward through drawing, and the open end is curled so as to be swaged on the sealing member 102.

The capacitor element 10 is a wound body like that shown in FIG. 2, for example. The wound body is formed by winding the anode foil 11 and the cathode foil 12. A dielectric layer (not shown) is formed on the surface of the anode foil 11. The capacitor element 10 includes a conductive polymer layer (not shown) disposed between the anode foil 11 (more specifically, the dielectric layer on the surface of the anode foil 11) and the cathode foil 12. The conductive polymer layer includes a layer (PL) containing a conductive polymer and an insulating material (I). The electrolytic capacitor 100 may contain a liquid component (L) (e.g., an electrolyte solution) impregnated into the capacitor element 10.

The outermost turn of the wound body is fixed with a winding end tape 14. Note that FIG. 2 shows a state in which a portion of the wound body is spread before the outermost turn of the wound body is fixed.

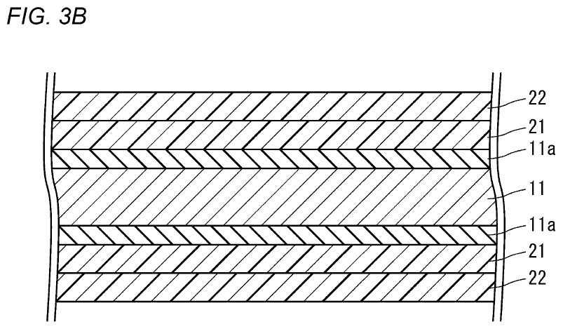

FIG. 3A schematically shows a partial cross section of an example of the anode foil 11 on which a conductive polymer layer is formed. As shown in FIG. 3A, dielectric layers 11a are formed on the surfaces of the anode foil 11. Conductive polymer layers 21 are formed on the dielectric layers 11a. Each conductive polymer layer 21 is the layer (PL) described above.

FIG. 3B schematically shows a partial cross section of another example of the anode foil 11 on which conductive polymer layers are formed. As shown in FIG. 3B, the dielectric layers 11a are formed on the surfaces of the anode foil 11. A conductive polymer layer 21 (first conductive polymer layer) and a conductive polymer layer 22 (second conductive polymer layer) are formed on each dielectric layer 11a. Each conductive polymer layer 21 is the layer (PL) described above. Each conductive polymer layer 22 is a conductive polymer layer that does not contain an insulating material (I).

The electrolytic capacitor only needs to include at least one capacitor element, and may include a plurality of capacitor elements. The number of capacitor elements included in the electrolytic capacitor can be determined depending on the application.

### (Additional Notes)

The above description of the embodiment discloses the following techniques.

### (Technique 1)

An electrolytic capacitor including:
a stacked body of an anode foil having a dielectric layer formed on a surface thereof and a cathode foil; and
a layer containing a conductive polymer and an insulating material disposed between the dielectric layer and the cathode foil,
wherein the insulating material is at least one kind of material selected from the group consisting of insulating fibers and insulating particles, and
no separator is disposed between the anode foil and the cathode foil.

### (Technique 2)

The electrolytic capacitor according to Technique 1,
wherein the layer further contains an additive containing hydroxy groups, and
a ratio Mh/Mt is 0.03 or more, where Mh is a total formula weight of the hydroxy groups contained in the additive and Mt is a molecular weight of the additive.

### (Technique 3)

The electrolytic capacitor according to Technique 1 or 2,
wherein the insulating fibers include fibers containing at least one kind of material selected from the group consisting of cellulose, rayon, aramid, polyester, polyimide, and nylon.

### (Technique 4)

The electrolytic capacitor according to any one of Techniques 1 to 3,
wherein the insulating particles include particles containing at least one kind of material selected from the group consisting of polyolefin, polyester, polytetrafluoroethylene, and ceramic.

### (Technique 5)

The electrolytic capacitor according to any one of Techniques 1 to 4,
wherein the stacked body is a wound body of the anode foil and the cathode foil.

### (Technique 6)

The electrolytic capacitor according to any one of Techniques 1 to 5,
wherein the stacked body is impregnated with a liquid component.

### (Technique 7)

A manufacturing method for manufacturing an electrolytic capacitor including an anode foil having a dielectric layer formed on a surface thereof and a cathode foil, the manufacturing method including:
a step (i) of applying a dispersion containing a conductive polymer and an insulating material to at least one element selected from the dielectric layer and the cathode foil, and drying the dispersion, thereby forming a layer containing the conductive polymer and the insulating material on the at least one element; and
a step (ii) of stacking the anode foil and the cathode foil such that the layer is disposed between the dielectric layer and the cathode foil, thereby forming a stacked body, the step (i) and the step (ii) being carried out in the stated order,
wherein the insulating material contains at least one kind of material selected from the group consisting of insulating fibers and insulating particles, and
in the step (ii), the anode foil and the cathode foil are stacked with no separator therebetween.

### (Technique 8)

The manufacturing method according to Technique 7,
wherein the dispersion contains an additive containing hydroxy groups, and water serving as a dispersion medium, and
a ratio Mh/Mt is 0.03 or more, where Mh is a total formula weight of the hydroxy groups contained in the additive and Mt is a molecular weight of the additive.

### (Technique 9)

The manufacturing method according to Technique 7 or 8,
wherein the insulating fibers include fibers of at least one selected from the group consisting of cellulose, rayon, aramid, polyester, polyimide, and nylon.

### (Technique 10)

The manufacturing method according to any one of Techniques 7 to 9,
wherein the insulating particles include particles containing particles of at least one selected from the group consisting of polyolefin, polyester, polytetrafluoroethylene, and ceramic.

### (Technique 11)

The manufacturing method according to any one of Techniques 7 to 10,
in the step (ii), the anode foil and the cathode foil are stacked by winding the anode foil and the cathode foil.

### (Technique 12)

The manufacturing method according to any one of Techniques 7 to 11, further including:
a step (Z) of impregnating the stacked body with a liquid component after the step (ii).

### EXAMPLES

The following describes the present disclosure more specifically based on examples, but the present disclosure is not limited to the examples.

### Experimental Example 1

In Experimental Example 1, a plurality of electrolytic capacitors were produced and evaluated by the following methods.

### (Capacitor A1)

An electrolytic capacitor (capacitor A1) was produced using the following method.

### (a) Preparation of Constituent Members

Surfaces of an aluminum foil (thickness: 100 μm) were roughened by performing etching on the aluminum foil. Dielectric layers were formed on the roughened surfaces of the aluminum foil by performing chemical conversion treatment. Thus, an anode foil having the dielectric layers on both surfaces thereof was obtained. Surfaces of an aluminum foil (thickness: 50 μm) were roughened by performing etching on the aluminum foil to obtain a cathode foil.

### (b) Preparation of Dispersion (d1)

A dispersion liquid (commercially available product) in which particles of poly(3,4-ethylenedioxythiophene) (PEDOT) doped with polystyrene sulfonic acid (PSS) were dispersed in water was prepared. A mixture of the insulating fiber of cellulose (insulating material (I)) and the additive (A) were added to this dispersion liquid to obtain a dispersion (d1). In the dispersion (d1), the content of the insulating fiber was set to 0.2% by mass, and the content of the additive (A) was set to 5.0% by mass. The content of the PEDOT in the dispersion (d1) was set to 2.0% by mass. Ethylene glycol was used as the additive (A).

### (c) Formation of Conductive Polymer Layer

The dispersion (d1) was applied to one surface of the anode foil (a surface of a dielectric layer) with use of a gravure coater. Thereafter, drying was performed to form a conductive polymer layer on the one surface of the anode foil (the surface of the dielectric layer). The drying was performed by heating the anode foil, to which the dispersion (d1) had been applied, at 125° C. for 5 minutes. Next, a conductive polymer layer was formed on another surface of the anode foil (a surface of a dielectric layer) using the same method. Conductive polymer layers were formed on both surfaces of the cathode foil using the same method as that used to form the conductive polymer layers on both surfaces of the anode foil.

### (d) Production of Capacitor Element

The anode foil and the cathode foil were each cut into a predetermined size. An anode lead tab and a cathode lead tab were connected to the anode foil and the cathode foil. Next, the anode foil and the cathode foil were wound without a separator disposed therebetween. An anode lead wire and a cathode lead wire were respectively connected to end portions of the lead tabs protruding from the wound body. Chemical conversion treatment was performed again on the obtained wound body, and the dielectric layer was formed on an end surface of the anode foil. An end portion of an outer surface of the wound body was fixed with a winding end tape to obtain a capacitor element.

(e) Impregnation with Liquid Component

An electrolyte solution (liquid component (L)) was prepared by dissolving o-phthalic acid and triethylamine (base component) at a total concentration of 25% by mass in ethylene glycol (solvent). The capacitor element was immersed in the electrolyte solution for 5 minutes in a reduced pressure atmosphere (40 kPa). Thus, the capacitor element (stacked body) was impregnated with the electrolyte solution.

### (f) Sealing of Capacitor Element

An electrolytic capacitor like that shown in FIG. 1 was produced by sealing the capacitor element impregnated with the electrolyte solution. Thereafter, aging was performed at 95° C. for 90 minutes while applying a voltage to the electrolytic capacitor. Thus, the electrolytic capacitor (capacitor A1) was obtained.

### (Production of Capacitor C1)

An electrolytic capacitor (capacitor C1) was produced using the following method.

(a) Preparation of Dispersion (cd1)

A dispersion (cd1) was prepared using the same method and under the same conditions as for the production of the dispersion (d1), except that no insulating fibers were added. The dispersion (cd1) is a dispersion in which particles of poly(3,4-ethylenedioxythiophene) (PEDOT) doped with polystyrene sulfonic acid are dispersed in water.

The capacitor C1 was produced using the dispersion (cd1) and using the same method as that for the capacitor A1, except that the dispersion used to form the conductive polymer layer on each constituent member was changed as shown in Table 1.

### (Evaluation)

The withstand voltage and equivalent series resistance (ESR) at 100 kHz were measured for each of the capacitors produced. Note that the evaluation was performed by preparing three capacitors for each of the capacitors A1 and C1 and calculating the arithmetic mean of the measured values.

Table 1 shows some of the conditions for forming the conductive polymer layers and the evaluation results. The capacitors A1 is the capacitor (E) according to the present embodiment, and the capacitor C1 is a capacitor according to a comparative example. Each withstand voltage and each ESR in Table 1 are the arithmetic mean values of the measured values of three capacitors.

TABLE 1

| | Applied Dispersion | | Evaluation (Mean Value) | |
|---|---|---|---|---|
| | On Dielectric | On Cathode | Withstand | |
| Capacitor | Layer | Foil | Voltage (V) | ESR (mΩ) |
| A1 | d1 | d1 | 27.5 | 11.1 |
| C1 | cd1 | cd1 | 4.1 | 8.1 |

As shown in Table 1, the withstand voltage was maintained by using the dispersion (d1) to which insulating fibers were added, even without a separator. Furthermore, the ESR of the capacitor A1 was approximately equal to the ESR of the comparative example C1. Thus, according to the present embodiment, a highly reliable electrolytic capacitor can be manufactured even without a separator.

### INDUSTRIAL APPLICABILITY

The present disclosure is applicable to an electrolytic capacitor and a method for manufacturing the same.

Although the present invention has been described with respect to a presently preferred embodiment, such disclosure should not be interpreted as limiting the present invention. Various modifications and alterations will undoubtedly become apparent to those skilled in the art to which the present invention pertains upon reading the above disclosure. Therefore, the appended claims should be interpreted to include all modifications and alterations without departing from the true spirit and scope of the present invention.

### REFERENCE SIGNS LIST

10: capacitor element, 11: anode foil, 12: cathode foil, 14: winding end tape, 100: electrolytic capacitor, 101: bottomed case, 102: sealing member, 103: base plate

1. An electrolytic capacitor comprising:
a stacked body of an anode foil having a dielectric layer formed on a surface thereof and a cathode foil; and
a layer containing a conductive polymer and an insulating material disposed between the dielectric layer and the cathode foil,
wherein the insulating material is at least one kind of material selected from the group consisting of insulating fibers and insulating particles, and
no separator is disposed between the anode foil and the cathode foil.

2. The electrolytic capacitor according to claim 1,
wherein the layer further contains an additive containing hydroxy groups, and
a ratio Mh/Mt is 0.03 or more, where Mh is a total formula weight of the hydroxy groups contained in the additive and Mt is a molecular weight of the additive.

3. The electrolytic capacitor according to claim 1,
wherein the insulating fibers include fibers containing at least one kind of material selected from the group consisting of cellulose, rayon, aramid, polyester, polyimide, and nylon.

4. The electrolytic capacitor according to claim 1,
wherein the insulating particles include particles containing at least one kind of material selected from the group consisting of polyolefin, polyester, polytetrafluoroethylene, and ceramic.

5. The electrolytic capacitor according to claim 1,
wherein the stacked body is a wound body of the anode foil and the cathode foil.

6. The electrolytic capacitor according to claim 1,
wherein the stacked body is impregnated with a liquid component.

7. A manufacturing method for manufacturing an electrolytic capacitor including an anode foil having a dielectric layer formed on a surface thereof, and a cathode foil, the manufacturing method comprising:
a step (i) of applying a dispersion containing a conductive polymer and an insulating material to at least one element selected from the dielectric layer and the cathode foil, and drying the dispersion, thereby forming a layer containing the conductive polymer and the insulating material on the at least one element; and
a step (ii) of stacking the anode foil and the cathode foil such that the layer is disposed between the dielectric layer and the cathode foil, thereby forming a stacked body, the step (i) and the step (ii) being carried out in the stated order,
wherein the insulating material contains at least one kind of material selected from the group consisting of insulating fibers and insulating particles, and
in the step (ii), the anode foil and the cathode foil are stacked with no separator therebetween.

8. The manufacturing method according to claim 7,
wherein the dispersion contains an additive containing hydroxy groups, and water serving as a dispersion medium, and
a ratio Mh/Mt is 0.03 or more, where Mh is a total formula weight of the hydroxy groups contained in the additive and Mt is a molecular weight of the additive.

9. The manufacturing method according to claim 7,
wherein the insulating fibers include fibers of at least one selected from the group consisting of cellulose, rayon, aramid, polyester, polyimide, and nylon.

10. The manufacturing method according to claim 7,
wherein the insulating particles include particles containing particles of at least one selected from the group consisting of polyolefin, polyester, polytetrafluoroethylene, and ceramic.

11. The manufacturing method according to claim 7,
in the step (ii), the anode foil and the cathode foil are stacked by winding the anode foil and the cathode foil.

12. The manufacturing method according to claim 7, further comprising:
a step (Z) of impregnating the stacked body with a liquid component after the step (ii).
